(19) United States
(12) Patent Application Publication
(10) Pub. No.: US 2018/0281333 A1
(43) Pub. Date: Oct. 4, 2018

(54) CUSTOMISABLE DISPOSABLE TABLEWARE

(71) Applicant: Paul Dominic JOHNSON, Leicester (GB)

(72) Inventor: Paul Dominic JOHNSON, Leicester (GB)

(21) Appl. No.: 15/939,435

(22) Filed: Mar. 29, 2018

(30) Foreign Application Priority Data
Mar. 30, 2017 (GB) 1705154.1

(51) Int. Cl. B31B 50/00; B41M 5/00; B31B 50/10; B31B 50/16; B31B 50/88; B31B 50/74; B31B 50/59

(52) U.S. Cl. CPC B31B 50/006; B41M 5/0064; B31B 50/104; B31B 2105/001; B31B 50/88; B31B 50/741; B31B 50/59; B31B 50/16

(57) ABSTRACT

Apparatus and methods for manufacture of customisable disposable tableware, such as paper plates, is provided. A digital printer is arranged to receive a feed of sheet material for printing and a cutter is arranged receive the sheet material exiting the printer. The cutter cuts the profile of discrete articles of tableware from the sheet material and a press is arranged to receive the discrete articles of tableware exiting the cutter. The press presses the articles of tableware to impart a three-dimensional shape to the articles. The printer, cutter and press may be provided as part of a continuous, in-line system. The printer may receive graphics to be printed from a server, for example to allow printing of small batch orders of bespoke paper plates in an efficient manner.

The present invention relates to disposable tableware, such as so-called paper plates and bowls.

Conventional paper plates are formed by pressing sheet paper material into a plate shape having a central planar region and a circumferential rim. The resulting profile provides a degree of structural rigidity as well as serving to prevent foodstuffs sliding off the plate in use.

During formation of the plates, the sheet material is located between opposing press members. The opposing surfaces of the press members are correspondingly profiled such that when they are brought together onto the sheet, the sheet material is deformed to conform to the interface between the opposing press members, thereby providing the three-dimensional plate shape. Paper bowls and trays may be formed in a similar manner by altering the geometry of the press members accordingly.

A majority of paper tableware is undecorated, e.g. in the form of white paper plates. Patterned paper plates are provided in a small range of different patterns according to predefined designs. Decorated paper plates are conventionally produced in relatively large batches of each design with the relevant graphics being repeatedly printed onto the paper at a printing facility.

The pre-printed paper is then transported to one or more further site where it can be pressed to form the paper plates. Whilst such a system is suited to production of large volumes of paper plates to a common design, it is inefficient for smaller batches of different designs.

It is currently possible to order smaller batches of paper plates to a bespoke decorative design. However the production process mimics that of larger runs, with the design being first sent to a printing facility and the printed paper sheet material being delivered to one or more further facility for cutting and then pressing. This process is inefficient for small runs and leads to a significant increase in unit cost compared to large batch production.

Furthermore this conventional process can result in a significant time delay when attempting to coordinate larger numbers of small runs for different designs. In short, the existing process does not scale effectively. It is an important consideration that small batches of disposable tableware may be required for an individual event, such as a party, meeting or other social/business occasion. As such, it is important that quick turnaround and delivery of the bespoke tableware orders is possible if urgent customer demands are to be met.

The centralisation of production to large-volume manufacturing facilities, means that the production facility may be located a significant distance from the customer location. Whilst shipping time may be acceptable for production of large volumes of paper plates to a standard graphic design, such shipping time is not acceptable for small individual orders of personalised plates.

Thus there are a number of technical and practical reasons why personalised disposable tableware has not achieved any significant share of the potential market.

It is an object of the present invention to provide a method, apparatus and/or system for production of bespoke disposable tableware in an efficient manner. It may be considered an additional or alternative aim to provide a system for small batch production of bespoke disposable tableware which can meet end customer demands.

According to a first aspect of the invention there is provided apparatus for manufacture of disposable tableware comprising: a printer arranged to receive a feed of sheet material for printing; a cutter arranged receive the sheet material exiting the printer and to cut the profile of discrete articles of tableware from the sheet material; and a press arranged to receive the discrete articles of tableware exiting the cutter and to press said articles of tableware to impart a three-dimensional shape to the articles.

The printer, cutter and press may be provided in-line, e.g. as stations of a common manufacturing line. The printer, cutter and press may be provided in ordered sequence.

A sheet material feed system may be provided for conveying the sheet material from the printer to the cutter. The sheet material feed system may align the sheet material, e.g. a graphic printed on the sheet material, with the cutter. A continuous flow of sheet material may be provided from the printer to the cutter, e.g. through the laminator.

The sheet material feed system may advance the sheet material by a predetermined distance between the printer and cutter, e.g. so that the cutter cuts a profile that is aligned with a graphic applied to the sheet material by the printer. The predetermined distance may be set according to a size of the graphic or a size of the cut profile of the article of tableware.

The sheet material may be continuous between the printer and cutter. The sheet material may be drawn from a roll by the sheet material feed system. The roll may be located upstream of the printer. The sheet material may be drawn from the roll, through the printer to the cutter.

The feed system may comprise a driven roller. The driven roller may be driven by a motor having angular position control. The motor may comprise a stepper motor.

The feed system may be configured to maintain a tension in the sheet material, e.g. between the printer and cutter.

A controller may control the feed of the sheet material between the printer and cutter. The controller may control the timing of the graphic printed by the printer, e.g. based on any or any combination of: a distance between the printer and cutter; a speed of operation (e.g. cyclic operation) of the cutter; a position or orientation of the cutter (e.g. angular position); and, a feed rate/speed of the sheet material.

A common drive/motor may drive the driven roller(s) and cutter. The driven roller(s) and cutter may be driven via a common shaft.

The cutter may comprise a rotating cutter head. The cutter head may be cylindrical and may comprise a cutting formation, e.g. a raised cutting formation such as an edge/blade. The cutting formation may extend in a circumferential direction over at least a portion of the circumference of the cutting head. The cutting formation may or may not extend over a majority of the circumference of the cutting head. The cutting formation may extend over only a portion of the circumference of the cutting head so as to leave a gap between adjacent cuts.

The cutter may comprise opposing cutter head and support members. The cutter head and the support member may be mounted so as to undergo relative movement during the cutting process. The cutter head and support member may be rotatable in opposing directions.

A pressure cut may be formed between the cutter head and support member. The cutter head and support member may be mounted such that pressure is applied between the cutter head and support member with the sheet material there-between. The sheet material may lie on the support member.

The sheet material may comprise paper material. Alternatively, the sheet material may comprise a transparent sheet material, e.g. a film, arranged to be applied to a paper material once printed.

The paper material may comprise a weight of 150 to 250 or 300 gsm. The paper material may comprise a weight of 170-230 gsm, e.g. around 200 gsm. The paper material may comprise a card or card-like material.

The paper/card material may be up to, around or exactly 1 mm thickness, e.g. greater than 0.6, 0.8 or 0.9 mm and/or less than 1.4 or 1.2 mm thickness.

The printer may comprise a digital printer.

The press may comprise opposing press members. At least one press member may be arranged to be actuatable relative to the other between open and closed press conditions. Each press member may comprise one or more profiled press surface, e.g. facing the opposing press surface(s) of the opposing press member. A press surface may comprise a projection on one press member, whereas the opposing press surface of the opposing press member may comprise a recess.

The press surfaces of the opposing press members may be correspondingly shaped/profiled. A plurality of press surfaces on one press member may be aligned with a corresponding plurality of opposing press surface on another member. Alternatively a plurality of presses may be provided is it is desirous to press a plurality of the same or different articles of tableware concurrently.

The press surface may comprise a plate, bowl or tray profile.

One or more discrete article of tableware trapped between the opposing press members in the closed press condition may be formed into a three-dimensional profile.

Either or both press member may comprise a heater. The heater may heat the press surface. Either or both press member may comprise a body (e.g. a metallic body) and the heater may heat a portion of the body spaced form the press surface. The sheet material article within the press may be heated by conduction during pressing.

The press may hold the closed condition, i.e. whilst pressing the article(s) therein, for a predetermined dwell time and/or at a predetermined temperature. The dwell time may be greater than 0.5 seconds or 1 second.

The press may open and close relative to a vertical or upright direction, e.g. with the press members and respective press surfaces being substantially upright/vertical in use. The discrete articles may drop into and/or out of the press under gravity.

The apparatus may comprise a laminator arranged to apply a layer of further material onto either or both major face of the sheet material downstream of the printer. The laminator may be upstream of the cutter.

The laminator may comprise a continuous layer of the further material (e.g. a roll of the further material).

The laminator may lay down the layer of further material onto the printed surface of the sheet material. The laminator may comprise one or more roller arranged to press the further material onto the printed sheet material.

A plurality of rollers may be provided as part of the feed system and/or laminator. The sheet material may pass over a first side of one roller and an opposing side of the other/next roller. The rollers may be adjacent and/or offset in a flow direction of the sheet material. The rollers may be arranged one above the other. A laminated surface of the sheet material may be pressed against a roller.

The position of one or more roller may be adjustable/translatable, e.g. in a linear direction.

An ink curing station may be located downstream of the printer, e.g. between the printer and cutter, press or laminator. The ink curing station may comprise a photon emitter, such as a lamp. A UV lamp may be used. The ink curing station may comprise an LED, such as an array of LEDs. The photon emitter may be arranged across the width of the sheet material, e.g. to span a width of the cutter.

A transfer member or conveyor may transfer the discrete cut articles from the cutter to the press.

The apparatus may comprise collator arranged to collate the pressed articles of tableware downstream of the press. The collator may stack the articles in predetermined quantity.

The apparatus may comprise a common system controller or plurality of communicating controllers for managing collective/coordinated operation of the apparatus from printing to cutting, pressing and/or packaging/labelling.

The apparatus/printer may comprise a controller arranged to receive graphic data files for printing onto the sheet material. The controller may control the number of graphics printed onto the sheet material, the timing/location of printing the graphic and/or and the feed of the sheet material to the printer.

The press and/or collator may comprise a controller which may comprise a common apparatus controller for the printer and/or feed system or else which may be in communication with individual controllers thereof.

The printer/controller may receive an order for a predetermined number (e.g. a batch) of articles of tableware and/or a graphic to be printed on the articles. The printer may be controlled to print a predetermined number of graphics corresponding to the predetermined number of articles. The printer may print a further graphic or visual indicia accompanying the predetermined number of graphics on the sheet material.

The further graphic may comprise a visual indicia identifying the batch of articles, e.g. comprising a visual code.

The cutter may cut an article comprising the further graphic or visual indicia, e.g. so as to provide a further article serving as an identifier at the start/end of the batch.

The apparatus may comprise a reader arranged to inspect the individual graphics or discrete articles. The reader may be part of the collator or upstream of the collator, e.g. downstream of the cutter.

The reader may identify the visual indicia and control any or any combination of a collation, packaging and/or labelling operation based upon said indicia.

The visual indicia may correspond to order data stored in a data store, e.g. a database, accessible to a controller. The order data may comprise a number of articles to be supplied for the order and a delivery address.

The collator may count a number of collated articles and check the number of collated articles against the number of articles recorded in the order data. The collator may package and/or apply a delivery label to the collated articles according to the data stored for the visual indicia in the data store.

According to a second aspect of the invention, there is provided a system for manufacture of disposable tableware, the system comprising the apparatus of the first aspect and a web server hosting a web site, the web site comprising a user interface for upload or selection of one or more graphic for printing by the printer.

The web site may comprise an ordering facility, arranged to transmit an order for a number of articles of tableware and an associated graphic to the apparatus.

The web site may comprise a user interface for entry of order and/or delivery information. The user interface may comprise one or more text entry box/filed. The user interface may comprise one or more delivery address entry field. The order and/or delivery information may be communicated to the apparatus.

The web site may comprise customer payment/transaction functionality.

The web site enabled system allows direct ordering and delivery of customised disposable tableware to the customer direct from the manufacturer.

According to a third aspect of the present invention, there is provided a method of manufacture or supply of disposable tableware corresponding to the respective first or second aspects of the invention.

According to a fourth aspect of the invention, there is provided a paper plate product produced according to the method of the third aspect or using the apparatus or system of the first or second aspect.

The skilled addressee will understand that any of the optional features defined above in relation to any one aspect of the invention may be applied to any other aspect of the invention wherever practicable.

Embodiments of the invention will be described in further detail below, by way of example only, with reference to the accompanying drawings of which:

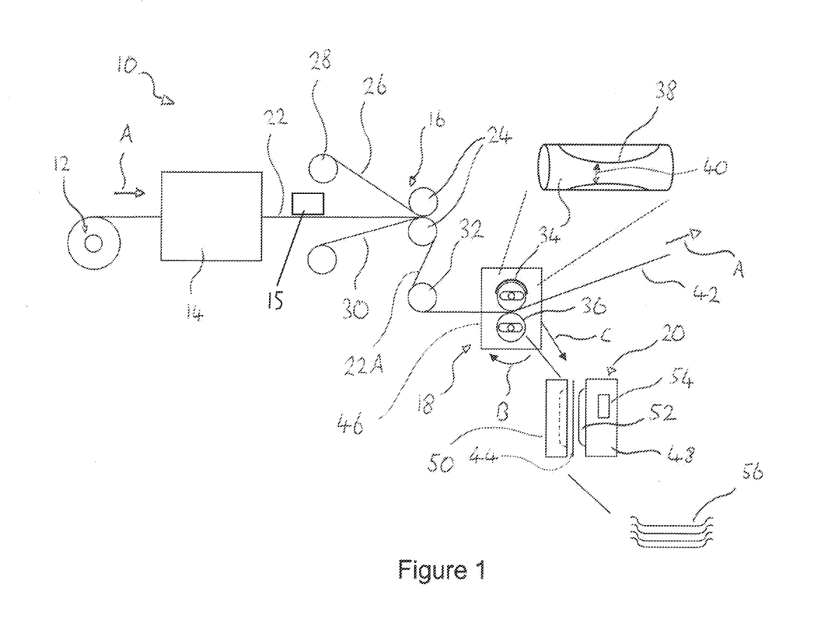

FIG. 1 is a schematic of manufacturing apparatus for disposable tableware according to an example of the invention;

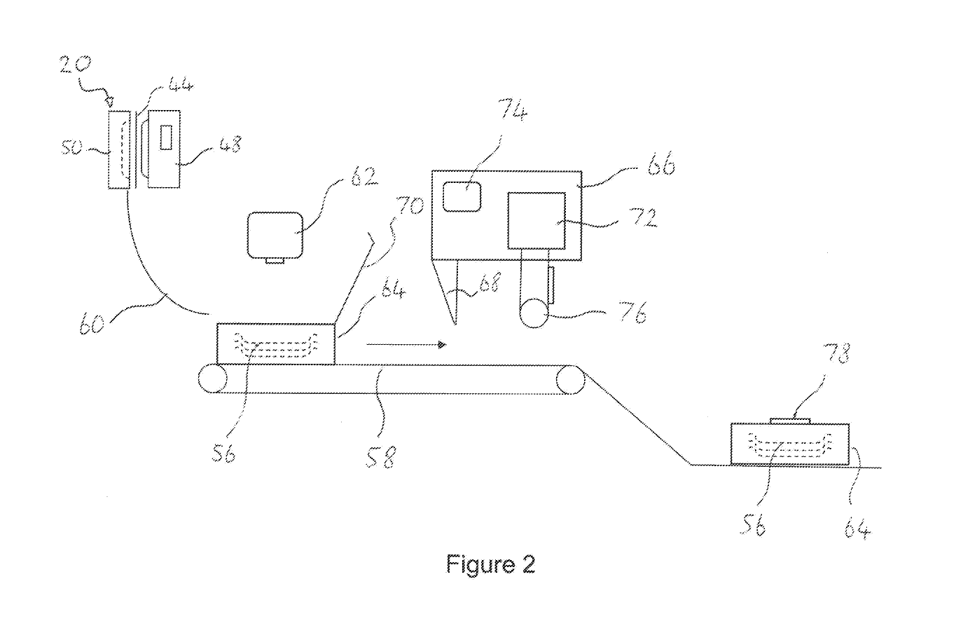

FIG. 2 is schematic view of collation and packaging/labelling apparatus according to a further example of the invention; and

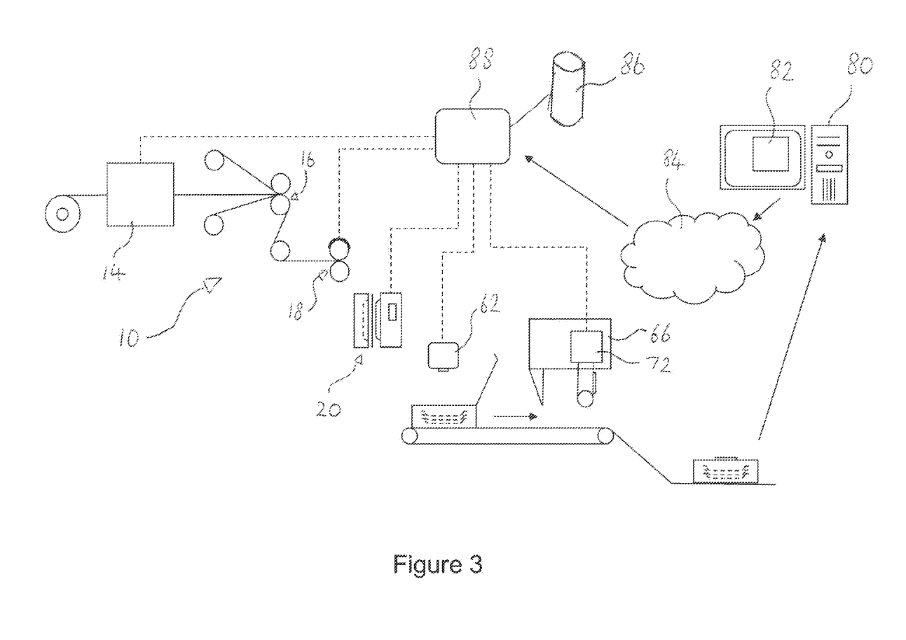

FIG. 3 is a schematic of an overall system for providing customised disposable tableware according to a further example of the invention.

The invention derives from the ability to receive a graphic file (e.g. as part of an order) for bespoke disposable tableware products and to print, cut and press small batches of said products in-line for efficient turnaround of the order.

Turning firstly to FIG. 1, there is shown apparatus 10 for forming customisable paper plates according to an example of the invention. The apparatus comprises in series a roll of paper 12, a digital printer 14, a laminating station 16, a cutting station 18 and a press 20.

Sheet paper 22 is drawn from the roll 12 through the printer 14, laminating station 16 and cutting station 18 in the direction of arrows A as will be described below in further detail below. The direction of arrows A define a flow direction of the paper 22 through the apparatus. The printer 14, laminating station 16, cutting station 18 and press 20 are provided in series in the flow direction with the paper product exiting each station being fed to the next. Thus the apparatus 10 provides an in-line system in which flow/transfer from one station to another can be fully automated.

The printer 14 comprises a digital printer allowing a continuous feed of paper through the device. An industrial digital printer may be used having a print head which is moveable over a defined print bed area relative to a moving/static paper feed there-through. Conventional industrial printers have been found to offer suitable printing quality and resolution for the present invention, further details of which will not be discussed for brevity since they are available to the person skilled in the art.

The printer 14 is supported on a moveable mount, such that the printer can be selectively moved into position over the feed of paper 22 or moved aside to allow plain paper to be delivered to the remainder of the apparatus 10. In alternative examples, the printer could simply be deactivated to allow plain products to be produced. Thus the apparatus can selectively allow plain or bespoke products to be made as desired.

In the embodiment shown in FIG. 1, the printer prints on the upward facing side of the paper 22 only. However in other examples, the printer may print on both sides.

A curing station 15 comprises an array of UV light emitting diodes (LEDs) held closely over the printed side over the paper exiting the printer 14. The printed side of the paper is thus irradiated as it passes under the lamp so as to cure the ink. Rapid curing of the ink printed onto the paper is beneficial in ensuring correct adherence of the laminating film to the printed paper, as well as helping to ensure print quality. If both sides of the paper are printed, lamps could be provided on both sides of the paper if desired.

The paper with the cured printed graphic passes to the laminating station 16.

The laminating station 16 comprises one or more roller 24 over which the paper passes. In this example, pair of rollers 24 is provided such that the paper passes between the rollers and is contacted on opposing sides by the rollers as it passes there-between.

The laminating station 16 also comprises a feed of transparent laminating film 26 applied onto the printed surface of the sheet paper 22. The laminating film 26 is fed from a roll 28, from which the film is drawn by motion of the paper 22. In this regard the laminating film is applied to the printed surface of the paper 22 as it passes between the pair of rollers 24. The close contact between the rollers 24 applies pressure to the laminating film and underlying paper 22 such that the laminating film is applied to the paper surface. Thus the paper acts as a substrate to which the film is applied as an outer protective layer.

The laminating film 26 may comprise a pressure applied film, an adhesive film or a thermally applied film if desired. If thermal film is used, the rollers 24 may be heated to ensure correct application onto the paper substrate.

An additional feed of laminating film 30 is shown beneath the paper 22. Thus laminating film 30 may be applied to the underside of the paper concurrently with film 26 if it is desired to provide a protective film on both major faces of the table where article once formed. The film 30 is applied in the same manner as described above by drawing the film onto the paper surface and nipping it as it passes through the rollers 24.

The laminated paper 22A passes from the laminating station 16 over intermediate roller 32 to the cutting station 18. The intermediate roller 32 may or may not be present. The intermediate roller 32 is beneath the roller(s) 24 thereby causing the paper to pass over roller 24 and then under roller 32. This may promote friction with the rollers and/or allow tension to be applied in the paper 22A if needed to ensure accurate/one-to-one motion of the paper over the rollers without slippage.

The cutting station 18 comprises a pair of opposing rollers. The upper roller 34 comprises a cutting roller whilst the lower roller 36 comprises a supporting/feed roller.

The upper roller 34 is shown in an enlarged three dimensional view above the cutting station 18. The roller 34 is generally cylindrical in shape having a raised cutting edge 38 forming a closed loop or circuit over the outer cylindrical surface. The cutting edge 38 in this example follows the shape of a circle in plan applied over the contour of the cylindrical plane defined by the roller 34 outer surface. Thus when the cutting edge 38 contacts the planar sheet of laminated paper 22A as it passes beneath the roller 34, a circular cut is progressively formed as the roller turns.

The raised cutting edge is formed of a metal, such as a hardened steel.

The opposing extremities of the cutting edge 38 are spaced on the roller 34 so as to leave a gap 40 there-between. The gap equates to a space between the articles cut from the printed sheet paper.

As the rollers 34 and 36 rotate in opposing directions (the direction of the rotation of lower roller 36 is shown by arrow B), the printed, laminated sheet 22A is drawn between the rollers and the cutting edge 38 is pressed against the sheet 22A and supporting roller 36. A pressure cut is formed in the sheet 22A between the cutting edge and supporting roller. In this example, the cut is circular in plan, thus forming circular cut outs from the sheet 22A.

The rollers 34 and 36 are mounted to a mounting block/plate 46 via respective pins/bolts. The bolts are located in elongate slots in the mounting plate 46 and tightened to hold the position of the rollers relative to the slots. However the bolts can be released to allow movement/repositioning of the rollers relative to the slots. The slots extend in the feed direction A of the paper and so the position adjustment of the rollers is range taking to allow adjustment of the length of paper extending between the printer and cutter 18. This adjustment allows the cutter to be aligned with graphics printed onto the paper by the printer 14 such that the cutting edge 38 encircles the graphic and forms a cut-out within which the graphic is correctly positioned.

Once the length of paper between the printer and cutter 18 is set it typically need not be adjusted for common sizes of paper plate. Thus the printer can print graphics aligned with the centre point of the shaped to be cut by the cutter 18 and/or at a spacing that corresponds to the spacing 40 between the extremities of the cutting edge 38.

In this example, the cutter has a scannable alignment feature, e.g. a visual indicator such as a colour, recess or raised feature. A sensor is used to detect the position of the alignment feature. This position data can be used to align the printed graphics with the cutter.

The alignment feature is aligned with a cutting edge of the cutter, in this example the leading edge of the cutter, and could comprise the cutter edge itself. For a known length of paper between the printer and cutter edge, the printer can be instructed to begin printing at a specific time (i.e. a paper location) that will correspond to the cut profile when the paper passes along the predetermined distance to the cutter. In this way, adjustment of the cutter location is not required and correct registration of the printed graphic with the cut profile is achieved by advancing or delaying the timing of the printer.

In the current example, using a rotary cutter means that the cyclic operation of the cutter can be set and the timing of the printer need only be set according to the cutter cycle at the start of operation of the apparatus/feed system. Once aligned, the printer can print cyclically in synchronisation with the cyclic operation of the cutter. This operation, may avoid the need to adjust the mounted position of the cutter.

The remaining, waste paper sheet 42 after cutting is draw away in the direction of arrow A and the circular cut-outs 44 pass in the direction of arrow C to the press 20. A chute or conveyor may be provided between the cutter and press 20 to ensure correct orientation of the cut-outs 44 into the press.

The press 20 comprises vertically oriented press members 48 and 50. Although not shown, the press members are typically mounted to common support rails or bars. One of the press members 48, 50 is actuatable in a linear direction towards the other, e.g. under the operation of a ram or screw actuator.

Press member 48 comprises a projecting press surface 52 defining one side of a paper plate profile to be formed during pressing. Press member 50 comprises a recess shapes to define the opposing side of a paper plate profile to be formed. When the press members 48 and 50 are open, a cut-out 44 is located between the press members 48, 50, which are subsequently closed to press the cut-out between the opposing press surfaces and thereby deform the cut-out 44 to conform to the pressed profile.

Either or both press member may comprise a heater 54. The combined pressure and heating of the laminated cut-out helps ensure that the cut-out 44 adequately retains its pressed profile. The temperature and dwell time of the press when closed are controlled by a controller or predetermined routine. The profiled plate 56 once formed starts cooling once the press members 48, 50 are opened and the paper plate 56 is ejected and allowed to cool further under ambient air.

In one example of the invention, the plates may be simply collated and stacked. Batches of plates according to a common design may be collated manually for packing and labelling. However FIG. 2 shows a more automated system in which collating, packing and/or labelling steps may be performed without manual intervention.

In the examples described above, any—or any combination—of rollers 24, 32, 34 and/or 36 may comprise a drive roller, for example driven by an electric motor under control of a system controller to be described below. The electric motor preferably provides variable speed control as well as fine control of angular adjustment such that it can start and stop over a suitably small fraction of a rotation. Additionally or alternatively, the paper may be drawn through the apparatus by applying tension to the waste paper 42 that is drawn away downstream of the cutting station 18.

Each roller could be driven independently, e.g. by a servo motor under the control of a system controller. However in the present example, all drive rollers, including the cutter, are driven off a common shaft from a single, common motor. This helps to ensure synchronicity of the cutter and rollers and print speed is matched to the throughput of paper governed by the motor.

In FIG. 2, the paper plates 56 are ejected from the press and fall under gravity towards a conveyor 58. A guide 60, such as a chute, ramp or similar, orients the falling plates 56 onto the conveyor 58 in a common fashion.

A visual inspection unit, e.g. reader/scanner, 62 is arranged with a field of view facing the printed surface of the paper plates exiting the press 20. In this example, the inspection unit 62 is arranged above conveyor 58 such that plates 56 pass beneath the unit 62 after exiting the press 20. In one example, the inspection unit could scan the graphic printed on each plate to determine which graphics conform to a common batch of plates sharing a common printed design. Thus the inspection unit 62 could determine the end of one batch and the start of the next batch, thereby allowing collating of batches of plates having a common printed design.

However in the present example, the inspection unit 62 comprises a simpler graphical code scanner, such as a bar code or QR code scanner. For each batch of plates, the printer 14 prints a predetermined number of graphics followed by a visual code after the final graphic. The visual code is printed in the location of the next plate to be cut from the printed paper sheet. Thus the visual code undergoes lamination and cutting/pressing in the same way as the printed plates forming the batch. However the code printed plate is used to provide control functionality for the collating and packing/labelling process.

A batch of printed plates is thus followed by a further ‘visual code’ plate. When the visual code is recognised by reader 62 it triggers the end of a collation stage.

In one example, individual plates may pass along the conveyor 58 past the reader 62 for collation and boxing/packaging downstream. However in this example, an open box 64 is located relative to the guide 60 to receive plates exiting the press. The plates 56 are stacked in the open box beneath the reader 62 until the reader sees a visual code plate, at which point the conveyor moves the box away from the collating point towards labelling station 66.

In this example a simple obstruction 68 is shown above the conveyor 58 to ride against the open lid 70 of the box, thereby closing the box as it passes beneath the obstruction 68. However it will be appreciated that a number of packaging, boxing and wrapping solutions are available in the art and may be applied in the context of the present invention for packaging the collated/stacked paper plates 56.

Once suitably packaged/boxed, the pack of plates 56 passes to the labelling station 66 which applies a label to the package. The label may comprise a common label design applied to all packs of paper plates. However in this example the label comprises a customisable delivery label. The labelling station comprises a label printer 72 and an applicator 76 for applying the printed label 78 to the box/pack of paper plates 56.

A data store 74 comprises a database of customer orders. Each data entry for an order comprises an order identifier, the quantity of paper plates, the recipient name and the delivery address. The order identifier corresponds to the visual codes (e.g. bar or QR codes) printed onto a plate by the printer 14. When scanned by reader 62, the database entry from the order is accessed and the delivery details retrieved and sent to the printer such that a label 78 can be printed with the delivery name and address for the collated batch of plates 56.

The printed label is then applied to the pack/box 64 containing the corresponding visual code plate, such that the package is ready to be dispatched for delivery to the customer by a postal/courier service.

In other examples of the invention it is conceivable that the visual code plate may be printed with both a visual code and also the delivery name/address details. Thus if that plate is the uppermost plate in a stack, the stack may be wrapped in a transparent wrapper ready for delivery, potentially without the need for an additional address label on the exterior of the wrapper. However such an embodiment would be dependent on the requirements of a delivery service handing the delivery to the customer.

Turning now to FIG. 3, there is shown an overview of a wider system for supply of bespoke disposable tableware, e.g. direct to a customer. The end customer accesses a web site or web portal hosted on a web server by the operator of the apparatus 10 or else an intermediary. The customer may access the web site using conventional computing equipment, such as a PC 80, laptop, tablet, smartphone. The user is presented with a user interface 82 which prompts the user to enter order details including the name of the recipient of the order, the delivery address and the number of tableware articles (e.g. paper plates) required.

The customer can select from a predetermined list of existing designs (e.g. which can be customisable by entry of text, or similar) or else can upload one or more image to use as the design for a graphic to be applied to the plates. In some examples, the web site comprises embedded graphic design tools, such that the customer can create a design from scratch or modify an existing design/image via interaction with the web site. The tools typically allow addition of text or other alphanumeric characters to a blank design or graphic. The user interface 82 may comprise a display window for showing the design in situ on a visual model/representation of a paper plate.

The customer uploads the design/image desired for the plates or confirms a selection of an existing design, e.g. with to without user customisation. A transaction interface or web page allows payment to be made via the web site.

The design/image and associated order data is transmitted via a wide area network, such as the web 84, to the web server and stored in a data store 86 that is accessible to a controller 88 of the manufacturing apparatus 10 as hereinbefore described.

The controller 88 transmits the design/image data from the data store 86 to the printer along with the associated visual code data. The web server and/or controller comprises software for converting the received images to a suitable printable format. In the present example, the software ensures the size and position of the graphics (e.g. in terms of pixel sizing/dimensions and location) and arranges graphics in sequence so as to define a continuous/ongoing print run. In this way orders follow sequentially in the print run as a continuous stream and the individual orders are separated at the collation stage as hereinbefore described without requiring any cessation of production.

The controller logs the visual code data against the order record in the database for subsequent retrieval.

The controller may additionally monitor the rotation of one or more rollers of the laminator, paper feed or cutter 18, or an associated drive motor. The controller may control starting/stopping of the paper feed and/or rate of feed.

The controller may monitor the number of pressing cycles and/or control any of the aforementioned pressing control parameters, such as temperature, dwell time, pressure, or the like.

The controller 88 receives the output of the visual inspection unit 62. When a visual code is scanned, the controller looks up the database record for the scanned code and sends the delivery data to the label printer for application to the batch. The controller may also maintain a count of press operations and/or plates scanned by the reader 62 since the start of the batch to double-check the quantity of plates in the batch prior to closing and labelling the box/package.

Once dispatched, the controller may update the order status to completed/dispatched in the database.

Any of the actions described above in relation to the controller 88 may be enacted by individual controllers associated with each station of the apparatus 10, rather than a general/common controller 88. Thus the controller 88 may comprise a plurality of controllers in communication with each other and/or a central controller that accesses the data store 86.

The apparatus, methods and system described herein make feasible the production and supply of bespoke paper plates in relatively small batch quantities direct to the end customer. The efficiency of the in-line printing and plate production steps means that bespoke plates can be delivered to meet urgent, e.g. next day orders, in a manner that has not been hitherto possible.

The invention makes it possible to provide small batches to a customer-specified design at reasonable cost for batches as small as, for example, 10, 20 or 30 items.

The press surface profile may comprise a base portion towards the centre of the profile and a rim formation towards the perimeter. The rim formation extends around the entire perimeter and comprises an increased depth relative to the base portion, which may be relatively flat/planar in form. The rim formation may comprise a series of angularly spaced radially-aligned grooves. Two sets of grooves may be provided for increased rigidity, e.g. with a first set of grooves being commencing radially inwardly of a second set of grooves. The different sets of grooves may be of different depth and/or radial length. The two sets of grooves may be interspersed. The depth of the grooves may increase from a radially inner end to a radially outer end of each groove. Either set of grooves may terminate at the outer edge/perimeter of the article or else radially inside the peripheral edge.

An outer rim edge or lip may be free of grooves and/or downwardly turned, e.g. to provide structural rigidity or hoop strength around the outer edge of the final product.

Whilst the above description discloses an apparatus and system for paper plate manufacture, it will be appreciated that the same system and apparatus can be used for other types of disposable tableware, such as bowls and/or trays, which require cutting and/or pressing from a sheet material after printing. The shape of the pressing surfaces and press settings may be altered according to the desired article of tableware to be manufactured.

Furthermore, whilst the substrate of the articles of kitchenware is referred to herein as ‘paper’ it is intended that this encompasses heavier paper materials, such as card. It is also envisaged that a printable paper substitute, or artificial paper, may be used in other examples if desirable.

In the above described specific examples of the invention, the paper material is printed and laminated with a film material. In other examples, the film layer may not be required. In yet further examples of the invention, the transparent film layer may be printed instead of, or in addition to the paper material and the printed film may be applied/laminated onto the sheet paper material prior to cutting and/or pressing of the discrete articles of tableware. In such examples, the printed side of the film material may be applied onto the paper sheet material.

1. Apparatus for manufacture of disposable tableware comprising:
a printer arranged to receive a feed of sheet material for printing;
a cutter arranged receive the sheet material exiting the printer and to cut the profile of discrete articles of tableware from the sheet material; and
a press arranged to receive the discrete articles of tableware exiting the cutter and to press said articles of tableware to impart a three-dimensional shape to the articles.

2. Apparatus according to claim 1, wherein the printer, the cutter and the press are arranged in ordered sequence as stations of a common manufacturing line.

3. Apparatus according to claim 1, comprising a sheet material feed system for conveying a continuous flow of the sheet material from the printer to the cutter, wherein the sheet material feed system advances the sheet material by a predetermined distance between the printer and cutter.

4. Apparatus according to claim 3 wherein the printer is controlled to print a graphic of predetermined size on the sheet material at a time or location on the sheet material arranged to be synchronised with the profile of the article of tableware cut by the cutter.

5. Apparatus according to claim 1, wherein the cutter comprises a rotating cutter head, the cutting head arranged to rotate in unison with and/or in a common direction with the feed of sheet material thereto.

6. Apparatus according to claim 1, wherein the cutter is operated according to a cutting cycle and the apparatus comprises a sensor for sensing the position or orientation of the cutter in said cutting cycle, the output of said sensor being used by a controller to control operation of the printer.

7. Apparatus according to claim 1, wherein the press comprises opposing press members, at least one press member being actuatable relative to the opposing press member between open and closed press conditions, each press member comprising a profiled press surface, the interface therebetween defining the shape of the discrete articles of tableware.

8. Apparatus according to claim 1, wherein the press comprises a heater and the press is held in the closed condition whilst pressing an article of tableware therein for a predetermined dwell time.

9. Apparatus according to claim 1, comprising a laminator arranged to apply a layer of further material onto either or both major face of the sheet material downstream of the printer.

10. Apparatus according to claim 9, wherein the sheet material comprises or consists of paper material and the further material comprises a transparent film, or vice versa.

11. Apparatus according to claim 1, comprising a controller arranged to receive graphic data files for printing onto the sheet material and to control printing of a predetermined number of graphics by the printer according to the received graphic data files, wherein the apparatus further comprises a collator for collating the pressed articles of tableware exiting the press, and the controller controls the collator to collate the predetermined number of pressed articles of tableware comprising the graphics of common design.

12. Apparatus according to claim 11, comprising a reader arranged to inspect the graphics and/or discrete articles, wherein the controller controls operation of the collator according to the output of the reader and/or wherein the apparatus comprises a data store comprising order data for batches of articles of tableware, the order data comprising a batch identifier for each batch of articles, wherein the output of the reader is correlated to the batch identifier by the controller.

13. Apparatus according to claim 1, wherein the printer is controlled to print a predetermined number of graphics corresponding to a predetermined number of articles to be made, the printer printing a visual indicia accompanying the predetermined number of graphics on the sheet material, the visual indicia comprising a code identifying a batch of articles.

14. Apparatus according to claim 1, comprising a web server hosting a web site, the web site comprising a user interface for upload or selection of one or more graphic for printing by the printer.

15. A method of manufacture of disposable tableware comprising:
feeding sheet material to a printer and controlling the printer to print graphics onto the sheet material;
controlling feed of the sheet material from the printer to a cutter arranged to cut the profile of discrete articles of tableware from the sheet material; and
feeding the discrete articles of tableware exiting the cutter to a press arranged to press said articles of tableware to impart a three-dimensional shape to the articles.
